(19) United States
(12) Patent Application Publication
(10) Pub. No.: US 2026/0288869 A1
(43) Pub. Date: Sep. 24, 2026

(54) INFORMATION PROCESSING DEVICE, DISPLAY CONTROL METHOD, AND DISPLAY CONTROL PROGRAM

(71) Applicant: NEC CORPORATION, Tokyo (JP)

(72) Inventors: Katsuya HAYAMI, Tokyo (JP); Masaki KOIZUMI, Tokyo (JP); Kenta KASAHARA, Tokyo (JP)

(73) Assignee: NEC CORPORATION, Tokyo (JP)

(21) Appl. No.: 19/490,977

(22) PCT Filed: Jun. 30, 2023
(86) PCT No.: PCT/JP2023/024311

§ 371 Date: Dec. 8, 2025

(51) Int. Cl. G06F 16/901; G06F 16/904

(52) U.S. Cl. CPC G06F 16/9024; G06F 16/904

(57) ABSTRACT

In order to make it possible to efficiently change the arrangement of nodes in a graph indicating the relationship between elements by using nodes and edges, an information processing device (1) comprises: a display control unit (11) that displays a graph in which nodes classified into the same group are associated; and a reception unit (12) that receives a change operation for display positions for the group. The display control unit (11) collectively changes the display positions of the nodes belonging to the group targeted for the change operation in accordance with the change operation.

### TECHNICAL FIELD

The present disclosure relates to an information processing device and the like that support analysis using a graph indicating a relationship between elements by using nodes and edges.

### BACKGROUND ART

Recently, a technique called causal analysis in which causal relationships between data are inferred has attracted attention, and accordingly, development of a technique for supporting the causal analysis has progressed. For example, PTL 1 below discloses a data analysis device that receives an input of variables indicating each event to be analyzed and an input of a causal direction between the variables, generates a causal relationship diagram indicating a causal relationship between the variables, and sets a variable designated as an objective variable in the causal relationship diagram and a variable closer to a cause side than the objective variable in the causal relationship diagram, in an analysis tool that analyzes a variable affecting the objective variable.

### CITATION LIST

### Patent Literature

PTL 1: JP 2020-86614 A

### SUMMARY OF INVENTION

### Technical Problem

The causal relationship diagram disclosed in PTL 1 is generated by causing an operator to input an arrow coupling between blocks with variable names given. Therefore, in a case where there are many variables, a complicated causal relationship diagram in which arrows are interlaced between a large number of blocks can be generated. The causal relationship diagram can be paraphrased as a causal graph. Similarly, the block can be paraphrased as a node, and the arrow can be paraphrased as an edge.

There is also a case where a causal relationship between elements is automatically inferred using an approach such as causal search for inferring what kind of causal relationship exists between a plurality of elements to be analyzed (or whether there is no causal relationship) from each element. In such a case, if a causal graph indicating a causal relationship between these elements is automatically generated, a causal graph in which edges connecting between nodes are irregularly interlaced and it is difficult to smoothly recognize the relationship between the nodes may sometimes be generated.

As described above, the arrangement of each node in the causal graph is not necessarily easy for the operator to recognize the causal relationship between the nodes. Even if the operator is allowed to change the arrangement of the nodes, since the causal graph may sometimes include a large number of nodes, adjusting the arrangement of the nodes one by one hinders smooth analysis. Such a disadvantage is not limited to the causal graph and is a disadvantage that occurs in common in cases where various sorts of graphs indicating a relationship between elements are displayed using nodes and edges.

A form of the present disclosure has been made in view of such a disadvantage, and an exemplary object of the present disclosure is to provide a technique that enables efficient change of arrangement of nodes in a graph indicating a relationship between elements by using nodes and edges.

### Solution to Problem

An information processing device according to one aspect of the present disclosure includes a display control means for displaying nodes classified into a same group in association with each other in a graph in which relationships between a plurality of elements are represented by the nodes relevant to each element and edges indicating the relationships between each element, and a reception means for receiving a change operation for display positions for the same group, in which the display control means collectively changes the display positions of the nodes belonging to the same group targeted for the change operation, in accordance with the change operation.

A display control method according to one aspect of the present disclosure includes displaying nodes classified into a same group in association with each other in a graph in which relationships between a plurality of elements are represented by the nodes relevant to each element and edges indicating the relationships between each element, receiving a change operation for display positions for the same group, and collectively changing the display positions of the nodes belonging to the same group targeted for the change operation, in accordance with the change operation, by at least one processor.

A display control program according to one aspect of the present disclosure causes a computer to execute a process of displaying nodes classified into a same group in association with each other in a graph in which relationships between a plurality of elements are represented by the nodes relevant to each element and edges indicating the relationships between each element, a process of receiving a change operation for display positions for the same group, and a process of collectively changing the display positions of the nodes belonging to the same group targeted for the change operation, in accordance with the change operation.

### Advantageous Effects of Invention

According to one form of the present disclosure, the arrangement of nodes in a graph indicating a relationship between elements by using nodes and edges can be efficiently changed.

### BRIEF DESCRIPTION OF DRAWINGS

FIG. 1 is a block diagram illustrating a configuration of an information processing device according to a first example embodiment of the present disclosure.

FIG. 2 is a flowchart illustrating a flow of a display control method according to the first example embodiment of the present disclosure.

FIG. 3 is a block diagram illustrating a configuration of an information processing device according to a second example embodiment of the present disclosure.

FIG. 4 is a diagram illustrating a display example of a causal graph.

FIG. 5 is a diagram explaining an example of changing a group by changing display positions of nodes.

FIG. 6 is a diagram explaining an example in which nodes to be grouped are selected after nodes to be displayed are narrowed down.

FIG. 7 is a flowchart illustrating a flow of a display control method according to the second example embodiment of the present disclosure.

FIG. 8 is a diagram illustrating an example of a computer that executes a command of a program that is software for achieving each function of each device according to each example embodiment of the present disclosure.

### EXAMPLE EMBODIMENT

### First Example Embodiment

A first example embodiment of the present disclosure will be described in detail with reference to the drawings. The present example embodiment is a basic mode of the example embodiment to be described later.

### Configuration of Information Processing Device

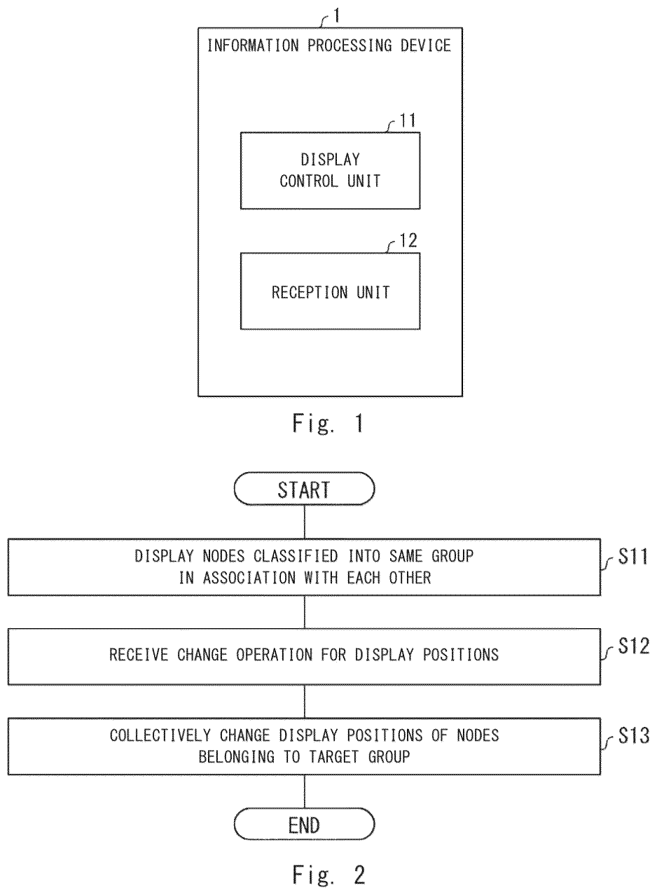

A configuration of an information processing device 1 according to the present example embodiment will be described with reference to FIG. 1. FIG. 1 is a block diagram illustrating a configuration of the information processing device 1. As illustrated, the information processing device 1 includes a display control unit 11 and a reception unit 12.

The display control unit 11 displays nodes classified into a same group in association with each other in a graph in which relationships between a plurality of elements are represented by the nodes relevant to each element and edges indicating the relationships between each element.

The reception unit 12 receives a change operation for display positions for the group. Then, the display control unit 11 collectively changes the display positions of the nodes belonging to the group targeted for the change operation, in accordance with the change operation received by the reception unit 12.

As described above, the information processing device 1 according to the present example embodiment includes the display control unit 11 that displays nodes classified into a same group in association with each other in a graph in which relationships between a plurality of elements are represented by the nodes relevant to each element and edges indicating the relationships between each element, and the reception unit 12 that receives a change operation for display positions for the group. Then, the display control unit 11 collectively changes the display positions of the nodes belonging to the group targeted for the change operation, in accordance with the change operation received by the reception unit 12. Therefore, according to the information processing device 1 according to the present example embodiment, an effect that the arrangement of nodes in a graph indicating a relationship between elements by using nodes and edges can be efficiently changed can be obtained.

### Display Control Program

The functions of the information processing device 1 described above can also be achieved by a program. A display control program according to the present example embodiment employs a configuration that causes a computer to execute a process of displaying nodes classified into a same group in association with each other in a graph in which relationships between a plurality of elements are represented by the nodes relevant to each element and edges indicating the relationships between each element, a process of receiving a change operation for display positions for the same group, and a process of collectively changing the display positions of the nodes belonging to the same group targeted for the change operation, in accordance with the change operation. Therefore, according to the display control program according to the present example embodiment, an effect that the arrangement of nodes in a graph indicating a relationship between elements by using nodes and edges can be efficiently changed can be obtained.

### Flow of Display Control Method

A flow of a display control method according to the present example embodiment will be described with reference to FIG. 2. FIG. 2 is a flowchart illustrating a flow of the display control method. The executing entity of each step in this display control method may be a processor included in the information processing device 1, or may be a processor included in another device, or executing entities of the steps may be processors provided in different devices from each other.

In S11, at least one processor displays nodes classified into a same group in association with each other in a graph in which relationships between a plurality of elements are represented by the nodes relevant to each element and edges indicating the relationships between each element.

In S12, at least one processor receives a change operation for display positions for the above group.

In S13, at least one processor collectively changes the display positions of the nodes belonging to the group targeted for the change operation, in accordance with the change operation received in S12.

As described above, the display control method according to the present example embodiment includes displaying nodes classified into a same group in association with each other in a graph in which relationships between a plurality of elements are represented by the nodes relevant to each element and edges indicating the relationships between each element, receiving a change operation for display positions for the same group, and collectively changing the display positions of the nodes belonging to the same group targeted for the change operation, in accordance with the change operation. Therefore, according to the display control method according to the present example embodiment, an effect that the arrangement of nodes indicating a relationship between elements by using nodes and edges can be efficiently changed can be obtained.

### Second Example Embodiment

### Configuration of Information Processing Device

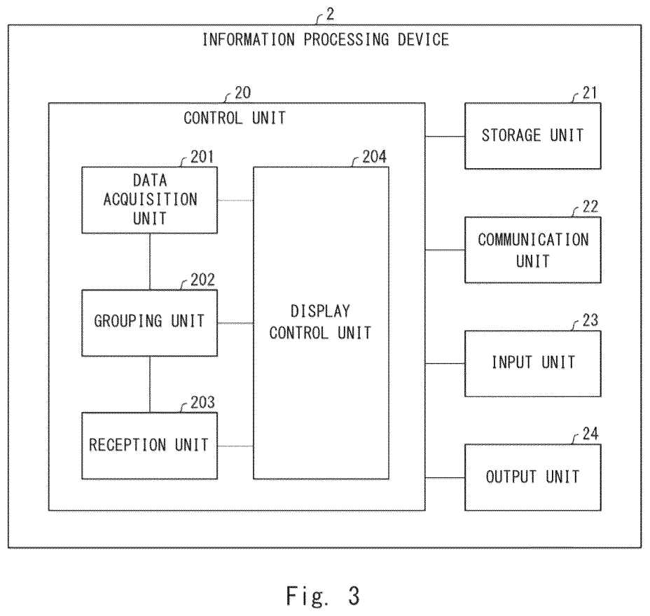

A configuration of an information processing device 2 according to the present example embodiment will be described with reference to FIG. 3. FIG. 3 is a block diagram illustrating a configuration of the information processing device 2. The information processing device 2 is a device having a function of supporting analysis using a causal graph. The information processing device 2 may be a device of which the main function is to support analysis using a causal graph, or may be a general-purpose device also having other functions.

The information processing device 2 can also support analysis using a graph other than the causal graph as long as the graph is a graph in which a relationship between a plurality of elements is represented by the nodes relevant to each element and edges indicating the relationship between each element. For example, since a graph such as a knowledge graph indicates a relationship between elements by using nodes and edges, the information processing device 2 can also support analysis using the knowledge graph or the like. Thus, the term “causal graph” in the following description can be replaced with any “graph” indicating a relationship between any elements by using nodes and edges. Similarly, the term “causal analysis” in the following description can be replaced with any “analysis” on any relationship between any elements.

As illustrated, the information processing device 2 includes a control unit 20 that comprehensively controls each unit of the information processing device 2 and a storage unit 21 that stores various sorts of data used by the information processing device 2. The information processing device 2 also includes a communication unit 22 for the information processing device 2 to communicate with another device, an input unit 23 that receives an input of various sorts of data into the information processing device 2, and an output unit 24 for the information processing device 2 to output various sorts of data. As illustrated, the control unit 20 of the information processing device 2 includes a data acquisition unit 201, a grouping unit 202, a reception unit 203, and a display control unit 204. Each component from the storage unit 21 to the output unit 24 may be built in the information processing device 2, or may be a device outside the information processing device 2 externally attached to the information processing device 2.

The data acquisition unit 201 acquires various sorts of data used for support of analysis using the causal graph. For example, the data acquisition unit 201 acquires analysis result data indicating a result of causal analysis. The analysis result data only needs to be data with which a causal graph can be displayed and may be, for example, data indicating each element that has been subjected to causal analysis and a relationship (causal relationship) between these elements.

The data acquisition unit 201 may acquire the analysis result data by performing causal analysis. Here, the causal analysis is an approach of inferring what kind of causal relationship exists between a plurality of elements (or whether there is no causal relationship) from each element with causal search and estimating the strength of the inferred causal relationship. As a specific approach of causal search, a method using a structural equation model, or the like is known, for example, and the data acquisition unit 201 may acquire the analysis result data generated by applying such a method. The result of causal analysis may be obtained by causal analysis using artificial intelligence (AI). By using AI, a causal relationship between elements subjected to causal analysis and its strength can be automatically estimated, and an analysis result is obtained. The AI used for the causal analysis is not particularly limited as long as the AI is formed to output information indicating a causal relationship between elements subjected to causal analysis and its strength by inputting those elements.

As in PTL 1, a causal graph may be generated by designating a causal relationship between elements by an operator, and in this case, the data acquisition unit 201 only needs to acquire the analysis result data indicating the designated content. In addition, the analysis result data may indicate, for example, a result of causal analysis involving natural language parsing. By using natural language parsing, it is also possible to infer a causal relationship between various sorts of elements relating to an open-ended questionnaire, from an answer to the questionnaire, for example. The causal graph may be an effective acyclic graph, may be a graph indicating a bidirectional causal relationship, or may be a graph indicating a looping causal relationship.

In a case where the data acquisition unit 201 does not perform causal analysis, the data acquisition unit 201 only needs to acquire the analysis result data generated by another device. A method for acquiring the analysis result data is not particularly limited. For example, the data acquisition unit 201 may acquire the analysis result data input by an operator of the information processing device 2 via the input unit 23, or may acquire the analysis result data from another device by communication via the communication unit 22. The same applies to a case where data other than the analysis result data is acquired.

The grouping unit 202 groups elements to be analyzed. Since each node included in the causal graph is relevant to one of the elements to be analyzed in a one-to-one manner, it can also be said that the grouping unit 202 groups each node included in the causal graph. A specific grouping approach will be described later.

The reception unit 203 receives various sorts of operations by the operator using the information processing device 2, in case of supporting analysis using the causal graph. For example, the reception unit 203 receives a change operation for a display position for a node or a group made up of a plurality of nodes in a displayed causal graph. The reception unit 203 receives various sorts of operations by the operator using the information processing device 2, in case of supporting analysis using the causal graph.

The display control unit 204 displays various sorts of information for supporting analysis using the causal graph, on a display device. The display device may be included in the information processing device 2, or may be a device outside the information processing device 2.

For example, the display control unit 204 displays a causal graph representing causal relationships between a plurality of elements to be analyzed by using nodes relevant to each element and edges indicating the causal relationships between each element. At this time, the display control unit 204 displays nodes classified into the same group in association with each other. Displaying nodes in association with each other means displaying the nodes in a form in which it can be recognized that the nodes are related to each other.

The display control unit 204 collectively changes the display positions of nodes belonging to a group targeted for a change operation for display positions for the group received by the reception unit 203, in accordance with the change operation.

As described above, the information processing device 2 according to the present example embodiment includes the display control unit 204 that displays nodes classified into a same group in association with each other in a causal graph in which causal relationships between a plurality of elements are represented by the nodes relevant to each element and edges indicating the causal relationships between each element, and the reception unit 203 that receives a change operation for display positions for the group. Then, the display control unit 204 collectively changes the display positions of the nodes belonging to the group targeted for the change operation, in accordance with the change operation received by the reception unit 203.

As mentioned earlier, in the above configuration, the “causal relationship” can be replaced with any “relationship”, and the “causal graph” can be replaced with any “graph” indicating a relationship between any elements by using nodes and edges.

For example, the data acquisition unit 201 may acquire a graph such as a knowledge graph (a graph that is not a causal graph). In this case, the display control unit 204 displays nodes classified into a same group in the acquired graph in association with each other. Then, the reception unit 203 receives a change operation for display positions for the group, and the display control unit 204 collectively changes the display positions of the nodes belonging to the group targeted for the change operation, in accordance with the change operation received by the reception unit 203. This makes it possible to efficiently change the arrangement of the nodes in the graph.

In this manner, according to the information processing device 2 according to the present example embodiment, an effect that the arrangement of nodes in a graph indicating a relationship between elements by using nodes and edges can be efficiently changed can be obtained.

As described above, the information processing device 2 according to the present example embodiment also includes the grouping unit 202 that groups the elements to be analyzed, and the display control unit 204 displays the nodes relevant to each element classified into the same group by the grouping unit 202, in association with each other. As a result, in addition to the effects attained by the information processing device 1 according to the first example embodiment, an effect that elements to be analyzed can be grouped by the information processing device 2 can be obtained even in a case where the elements to be analyzed are not grouped in advance.

### Display Example of Causal Graph

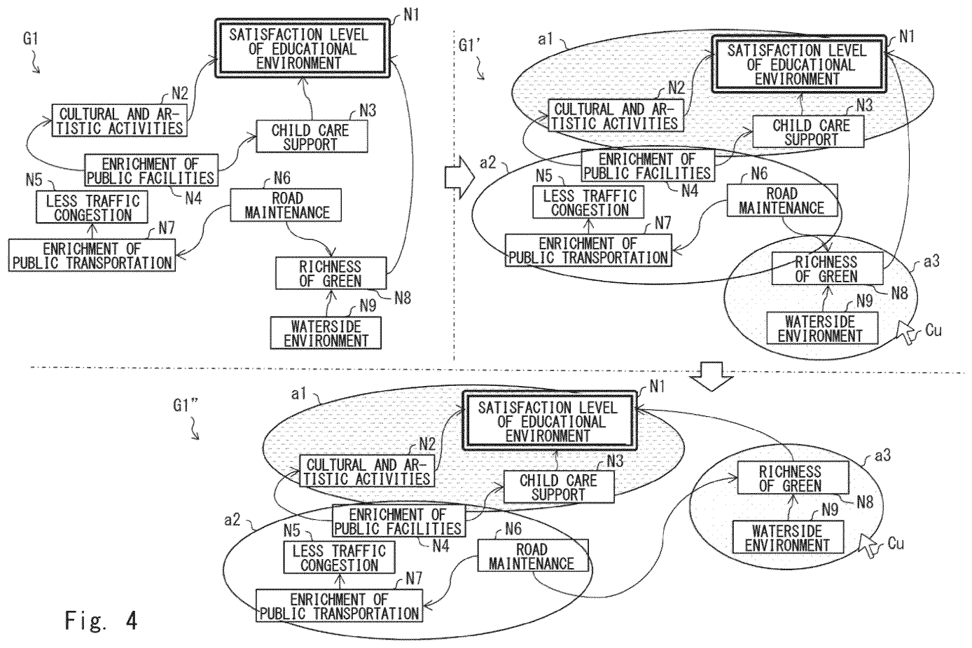

A display example of the causal graph by the information processing device 2 will be described with reference to FIG. 4. FIG. 4 is a diagram illustrating a display example of a causal graph. A causal graph G1 illustrated in the upper left of FIG. 4 represents causal relationships between a plurality of elements by using nodes N1 to N9 relevant to each element and edges (unidirectional arrows connecting between the nodes) indicating the causal relationships between each element.

In FIG. 4, each node has a name indicating its relevant element. For example, “cultural and artistic activities” described in the node N2 indicates a name given to the element of the node N2. In this manner, in case the causal graph is displayed, the names given to each element may be made relevant to the nodes relevant to each element and displayed.

The elements to be subjected to causal analysis can be classified into an objective variable and an explanatory variable that explains the objective variable. In the example in FIG. 4, the node N1 indicated by the double-line frame line is an element relevant to the objective variable, and all the other nodes are elements relevant to the explanatory variables. The elements to be subjected to the causal analysis may include an element other than the explanatory variable and the objective variable.

In the causal graph G1, the nodes are not displayed in association with each group. On the other hand, a causal graph G1′ illustrated in the upper right of FIG. 4 indicates causal relationships between the nodes N1 to N9, like the causal graph G1, but nodes classified into the same group are displayed in association with each other. Specifically, in the causal graph G1′, the nodes N1 to N3 are associated by being displayed on an elliptical object a1. Similarly, the nodes N4 to N7 are associated by being displayed on an object a2, and the nodes N8 and N9 are associated by being displayed on an object a3.

The nodes in the same group only need to be displayed in a form in which it can be recognized that these nodes are related to each other, and the display form is not limited to the example in FIG. 4. For example, as in FIG. 4, the nodes of the same group may be associated by being displayed in a display area relevant to that group, or the nodes of the same group may be associated by being displayed in the same color or similar colors.

The nodes associated with each other in the causal graph G1′, that is, the nodes belonging to the same group are formed in such a way that their display positions can be collectively changed. For example, the reception unit 203 may receive a change operation for the display positions of dragging the object a3 using a cursor Cu and dropping the object a3 at a desired position. Then, the display control unit 204 collectively changes the display positions of the nodes N8 and N9 on the object a3 in accordance with this change operation.

A causal graph G1″ illustrated on the lower side of FIG. 4 is obtained by moving the nodes N8 and N9 on the object a3 in the causal graph G1′. By collectively moving the nodes N8 and N9, the relationship between these nodes and other nodes (for example, the node N1) can be easily recognized. In this manner, according to the information processing device 2, the arrangement of nodes in the causal graph can be efficiently changed.

In the example in FIG. 4, the positional relationship between the nodes N8 and N9 inside the object a3 is unchanged before and after the display positions are changed. In this manner, in case of collectively changing the display positions of a plurality of grouped nodes, the display control unit 204 may change the display positions of the grouped nodes while maintaining the positional relationship between these nodes. As a result, it is avoided that it becomes difficult to understand the relationship between the nodes after the display positions are changed. The node positional relationship in case the display positions of a plurality of grouped nodes are collectively changed is not necessarily fixed. For example, the display control unit 204 may change the display positions of the nodes in such a way that the edges do not overlap. For example, in case of collectively changing the display positions of a plurality of grouped nodes, the display control unit 204 may arrange these nodes in order from the most upstream node in the causal relationship. As a result, the directions of the edges between the nodes can be put into an aligned state after the display positions are changed.

### Grouping Approach

As described above, the grouping unit 202 groups elements to be analyzed. The grouping approach is not particularly limited. For example, the reception unit 203 may receive designation of elements or nodes to be grouped from the operator, and in this case, the grouping unit 202 performs grouping in accordance with the designation by the operator.

The grouping unit 202 may automatically group elements to be analyzed, not via an operation by the operator. For example, if a grouping rule such as classifying all elements into any group and setting the number of elements in each group to two or more is defined in advance, the grouping unit 202 can group each element in accordance with the defined rule.

For example, the grouping unit 202 may classify a plurality of elements into a plurality of groups by exploratory factor analysis. As a result, in addition to the effects attained by the information processing device 1 according to the first example embodiment, an effect that the elements related to each other can be automatically grouped can be obtained.

The exploratory factor analysis is an analysis approach for estimating what factor brings about a correlation between a plurality of variables, based on a correlation coefficient between each variable. That is, in a case where a plurality of elements is classified into a plurality of groups by the exploratory factor analysis, elements included in each group are relevant to one factor that brings about a correlation between these elements. The number of groups for classification may be defined in advance, or may be designated by the operator. In the exploratory factor analysis, one element may be made relevant to a plurality of factors.

A plurality of elements to be subjected to causal analysis may include elements generated based on answers of respondents to a predetermined question. In this case, the grouping unit 202 may classify a plurality of elements generated based on the answers relevant to the same or related questions into the same group. As a result, in addition to the effects attained by the information processing device 1 according to the first example embodiment, an effect that the elements related to each other can be automatically grouped can be obtained. As mentioned earlier, the “causal analysis” in the above configuration can be replaced with any “analysis”.

The classification as described above can be performed by preparing, in advance, related data indicating what question each element is relevant to, the relevance between questions, and the like. The related data may be stored in advance in the storage unit 21 or the like, or may be acquired by the data acquisition unit 201.

For example, it is assumed that a questionnaire for asking predetermined target people to answer a plurality of questions such as “what is important in choosing a residence?” is conducted and answer results of the questionnaire are aggregated to create a plurality of elements (such as “enrichment of public facilities” and “richness of green”, for example) to be subjected to causal analysis. In this case, for each element, the grouping unit 202 only needs to classify elements relevant to the same question into the same group, using the related data indicating questions relevant to each element.

For example, in a case where a questionnaire using multiple questions according to some themes is conducted, the questions may be grouped for each theme. In this case, for each element, the grouping unit 202 only needs to classify elements relevant to questions belonging to the same group, that is, the mutually related questions into the same group, using the related data indicating the questions relevant to each element and the related data indicating the groups to which each question belongs.

The grouping unit 202 may identify an optimal group of each element, based on a form of temporal change in the value of each element. As a result, in addition to the effects attained by the information processing device 1 according to the first example embodiment an effect that each element can be automatically grouped according to the form of temporal change in the value of each element can be obtained.

In this case, the reception unit 203 may receive an input of time-series data of the value of each element. Then, the grouping unit 202 generates information indicating a form of changes in the value of each element (for example, a change rate or a change amount) from the time-series data. As a result, the grouping unit 202 can identify the optimal group of each element, in other words, optimize the groups to which each element belongs, based on the generated information.

The above-described time-series data may be acquired from, for example, a wearable device (such as a smart watch) worn by a user, may be acquired from a measuring instrument such as a scale used by the user, or may be acquired from a medical examination result or the like.

In case grouping each element based on the form of temporal change in the value, the grouping unit 202 may group each element, based on the magnitude of the change amount or the change rate. Whether the change amount or the change rate is large can be determined by comparing the change amount or the change rate with a predetermined threshold, or can be determined by comparing the change amount or the change rate with an average value of the change amounts or the change rates for each element. That is, the magnitude of the change amount or the change rate may be evaluated as absolute evaluation or relative evaluation.

It can be said that an element having a large change amount or change rate is an “unstable element”, and an element having a small change amount or change rate is a “stable element”. That is, in this case, the grouping unit 202 can separately group the “unstable element” and the “stable element”. For example, in a case where the change rate of the values of elements such as the amount of exercise and the sleeping time is large, the grouping unit 202 groups these elements as “unstable elements”. Information on such groups suggests that the user's lifestyle is irregular, and it is possible to prompt the user to improve the lifestyle.

In a case where the change rate of the values of elements such as the body weight and the body fat percentage is small, the grouping unit 202 groups these elements as “stable elements”. Information on such groups suggests that the user's dietary life is stable, and it is possible to prompt the user to continue the current dietary life.

As described above, the method of identifying the optimal group based on the form of temporal change of the value of each element is particularly effective in a case where the causal analysis is used in order for the user to gain a healthy lifestyle in the medical and healthcare field.

### Change of Group

The reception unit 203 may receive an operation for changing a group set for each element, and the grouping unit 202 may change the group in accordance with the received operation. What kind of change operation is to be made on the group is optional. For example, in case an operation for selecting a node in the displayed causal graph is performed, the display control unit 204 may display an option for changing the group of the element relevant to the selected node. Then, in case the reception unit 203 receives an operation to select the displayed option, the display control unit 204 may display a list of groups that are change destination candidates. In this case, the grouping unit 202 changes the group of the relevant element to a group selected from the displayed list.

For example, in a case where a node displayed in a predetermined display area associated with a certain group is moved to a predetermined display area associated with another group, the grouping unit 202 may change the classification of the element relevant to the moved node to another group from the certain group. As a result, in addition to the effects attained by the information processing device 1 according to the first example embodiment, an effect that the group can be easily changed by an intuitive operation can be obtained.

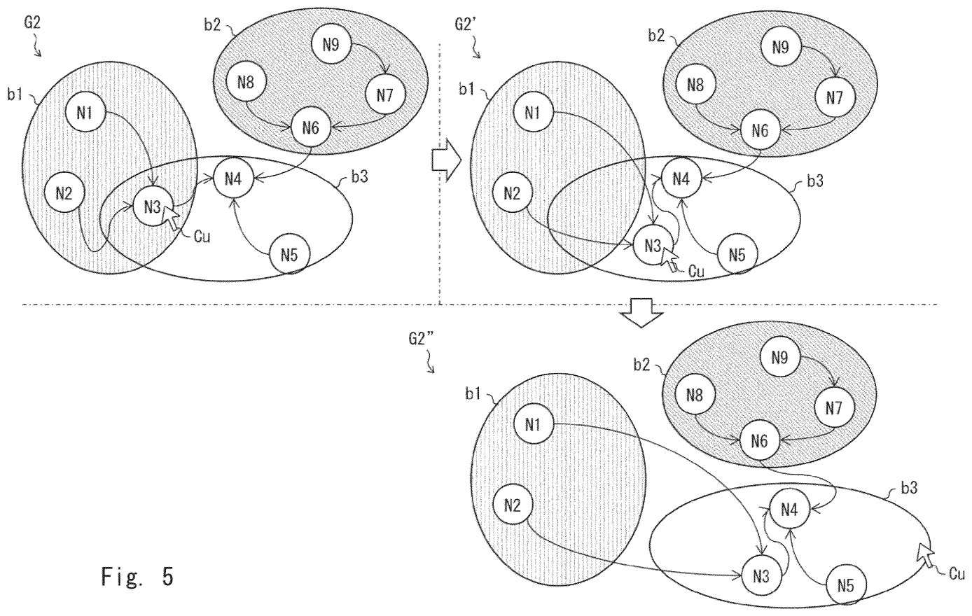

FIG. 5 is a diagram explaining an example of changing a group by changing display positions of nodes. A causal graph G2 illustrated in the upper left of FIG. 5 indicates a causal relationship between elements relevant to nodes N1 to N9, and these nodes are classified into three groups. Specifically, the nodes N6 to N9 classified into the same group are associated by being displayed on an object b2. The nodes N1 to N3 are associated by being displayed on an object a1, and the nodes N3 to N5 are associated by being displayed on an object b3. Hereinafter, the groups relevant to the objects b1 to b3 will be referred to as first to third groups, respectively.

Here, among the displayed nodes N1 to N9, the node N3 is displayed in the display area of the object b1 and in the display area of the object b3. This indicates that the element relevant to the node N3 belongs to both the first group and the third group. In this manner, the grouping unit 202 may allow one element to be classified into a plurality of groups. In this case, the display control unit 204 changes the display position of the node N3 regardless of which of the objects b1 and b3 is operated to change the display position. In this case, the display control unit 204 may deform the shape of both or one of the objects b1 and b3 in such a way that the node N3 after the change of the display position is within the display areas of both the objects b1 and b3.

The operator can also change the group of the element relevant to the node N3 by moving the node N3. For example, the operator may drag the node N3 with the cursor Cu and drop the node N3 outside the display area of the object b1 but within the display area of the object b3. As a result, the node N3 can be moved to a position outside the display area of the object b1 but within the display area of the object b3, and the group of the element relevant to the node N3 can be changed to only the third group from the first and third groups.

A causal graph G2′ illustrated in the upper right of FIG. 5 is obtained by moving the node N3 in the causal graph G2 out of the display area of the object b1 but into the display area of the object b3. The grouping unit 202 changes the group of the element relevant to the node N3 to only the third group in response to the above movement. As a result, in a case where a change operation for the display position for the first group is performed, the display position of the node N3 no longer varies.

The causal graph G2″ illustrated on the lower side of FIG. 5 is obtained by changing the display position of each node belonging to the third group in the causal graph G2′. In this manner, the operator can change the group of the element relevant to the node N3 by an intuitive operation of moving the display position of the node N3 into the display area of the object b3 after confirming the groups relevant to each node in the causal graph G2.

The element to be subjected to group change is not limited to an element belonging to a plurality of groups. The grouping unit 202 can also change an element belonging to one group to belong to another group or can put an element not belonging to any group to belong to any group, in accordance with an operation for changing a display position of a node similar to the above.

### Narrow Down of Nodes to Be Displayed

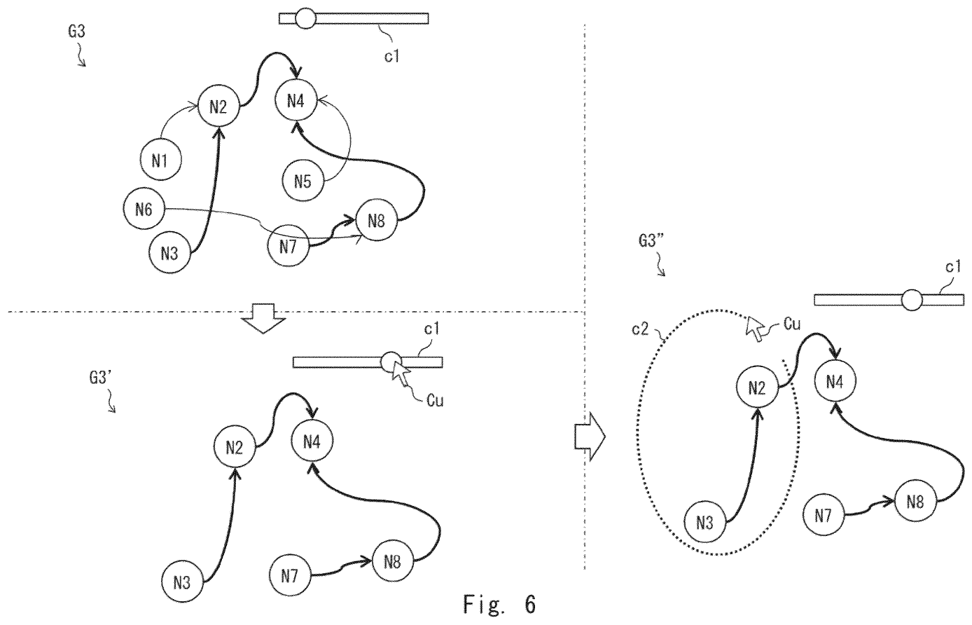

Here, in a case where the number of elements to be analyzed is large, or the like, the number of nodes included in the causal graph is also large, and edges connecting between the nodes are interlaced, which may sometimes make the causal graph difficult to understand the causal relationship. Therefore, the display control unit 204 may hide some of the nodes, and the grouping unit 202 may group the nodes being displayed (in other words, not hidden) as targets. This will be described with reference to FIG. 6. FIG. 6 is a diagram explaining an example in which nodes to be grouped are selected after nodes to be displayed are narrowed down.

A causal graph G3 illustrated in the upper left of FIG. 6 illustrates causal relationships between each of nodes N1 to N8. In the causal graph G3, the edges connecting between the nodes are displayed by lines having a thickness according to a path coefficient. In this manner, the display control unit 204 may display the edges in a display form according to the path coefficient. As a result, it is possible to cause the operator to recognize a more influential path and to smoothly analyze the relevance between each element. The path coefficient is a coefficient calculated using weight values of paths joining each element. The weight value can be calculated by a known causal inference or causal search approach. Besides the thickness of the edge, the path coefficient can also be represented by, for example, the length or color of the edge.

In the example in FIG. 6, the display control unit 204 displays an object c1 together with the causal graph G3. The object c1 is a threshold designation object that receives designation of a threshold of the path coefficient in the causal graph G3.

Specifically, the object c1 is an object in which a slider movable on a slider bar is arranged on the slider bar. The slider bar indicates a changeable range of the threshold of the path coefficient, and the position of the slider indicates the threshold of the path coefficient. In case the display control unit 204 displays such an object c1, the operator can change the threshold of the path coefficient by an intuitive and simple operation of shifting the slider on the slider bar.

As illustrated in the upper left of FIG. 6, the operator can display all the nodes and edges constituting the causal graph G3 by setting the threshold to a small value with the object c1. As illustrated in the lower left of FIG. 6, the operator can operate the object c1 with the cursor Cu to change the threshold to a larger value. The method for operating the object c1 is not limited to the method using the cursor Cu.

In a case where the threshold is changed, the display control unit 204 hides a node that is a start point of a path with a path coefficient less than the changed threshold. A causal graph G3′ illustrated at the lower left of FIG. 6 is obtained by hiding a node that is a start point of a path with a path coefficient less than the changed threshold, among the nodes included in the causal graph G3. As compared with the causal graph G3, it is easy in the causal graph G3′ to recognize paths whose path coefficients are equal to or more than the threshold and relationships between nodes included in these paths.

The index value serving as a reference for switching between displaying and hiding of the node is not limited to the path coefficient. That is, displaying and hiding of the node can be switched based on any index value as long as the index value is an index value relating to causal relationships between a plurality of elements. For example, the display control unit 204 may switch between displaying and hiding of the node, based on a P-value. In this case, the display control unit 204 only needs to display an object for changing a threshold of the P-value. In a case of the P-value, the threshold may be changed stepwise instead of being changed continuously.

The operator can group desired nodes after narrowing down the nodes to be displayed as described above. For example, in the causal graph G3′, an operation of surrounding the plurality of nodes with the cursor Cu may enable grouping of the surrounded nodes.

A causal graph G3″ illustrated on the right side of FIG. 6 illustrates an example of grouping target nodes by performing a drag operation in such a way as to surround the target nodes. In the causal graph G3″, a trace of the drag operation performed in the causal graph G3″ on a display screen with the cursor Cu is indicated by a broken line c2. In case the nodes N2 and N3 are surrounded by this broken line c2, the grouping unit 202 groups the elements relevant to these nodes.

The grouping approach while nodes to be displayed are in a narrowed down state is not limited to this example. For example, even in a case where the group is manually designated, a plurality of nodes desired to be grouped may be selected and the selected nodes may be grouped, or the nodes may be automatically grouped using the approach as described in “Grouping Approach” described above.

As described above, the reception unit 203 may receive designation of a threshold of a predetermined index value relating to causal relationships between a plurality of elements, and the display control unit 204 may switch between displaying and hiding of each node, based on the designated threshold. Then, the grouping unit 202 may group elements relevant to the displayed nodes, as targets. As a result, in addition to the effects attained by the information processing device 1 according to the first example embodiment, an effect that a group can be set after narrowing down nodes to be displayed and clarifying causal relationships between the elements can be obtained. As mentioned earlier, the “causal relationship” in the above configuration can be replaced with any “relationship”.

### Flow of Display Control Method

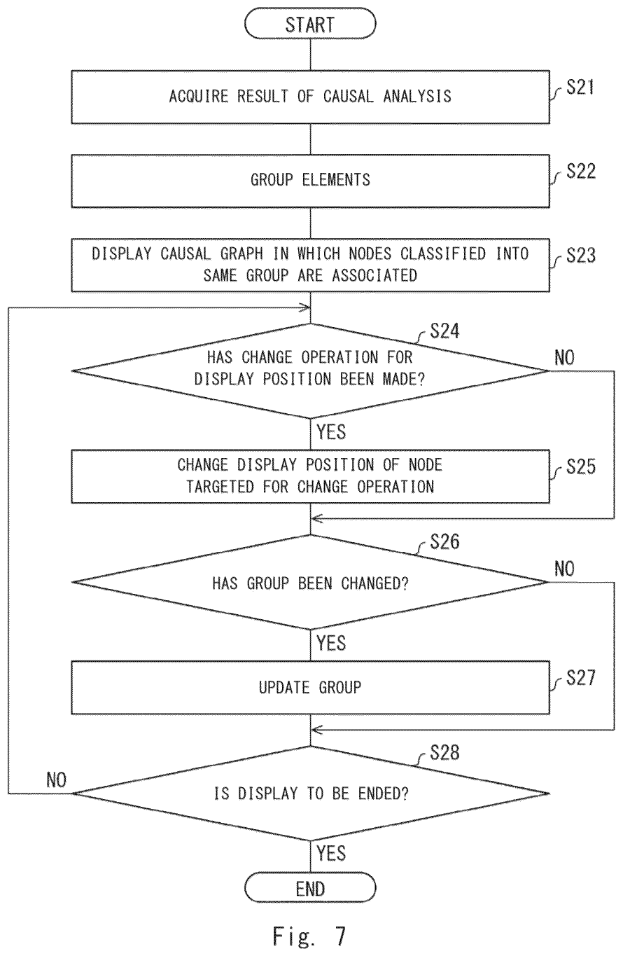

A flow of a display control method according to the present example embodiment will be described with reference to FIG. 7. FIG. 7 is a flowchart illustrating a flow of the display control method.

In S21, the data acquisition unit 201 acquires the analysis result data indicating a result of causal analysis. As described above, the data acquisition unit 201 may acquire the analysis result data by performing causal analysis, or may acquire the analysis result data indicating a result of causal analysis performed by another device.

In S22, the grouping unit 202 groups each element indicated by the analysis result data acquired in S21 and to be subjected to causal analysis. As described in the section “Grouping Approach”, a variety of approaches can be applied as the grouping approach.

In S23, the display control unit 204 displays a causal graph in which nodes classified into the same group in S22 (more precisely, nodes relevant to elements classified into the same group) are associated.

In S24, the reception unit 203 determines whether a change operation for a display position has been made. Specifically, in case of receiving a change operation for a display position for a single node or a group of nodes, the reception unit 203 determines that the change operation has been performed (YES in S24) and proceeds to S25. On the other hand, in a case where the reception unit 203 determines that no change operation has been performed (NO in S24), the process proceeds to S26.

In S25, the display control unit 204 changes the display position of the node targeted for the change operation. Specifically, in a case where a change operation for a display position of a single node has been received, the display control unit 204 changes the display position of the single node in accordance with the received change operation. Meanwhile, in a case where a change operation for display positions for a group of nodes has been received, the display control unit 204 collectively changes the display positions of the nodes belonging to the group targeted for the change operation. For example, in a case where nodes belonging to the same group are displayed on the same object as in the examples in FIGS. 4 and 5, an operation of changing the display position of that object may be regarded as a change operation for the display positions for the group of nodes.

In S26, the grouping unit 202 determines whether there has been a group change. Specifically, the grouping unit 202 determines that the group has been changed (YES in S26) in a case where both of the following conditions (1) and (2) are satisfied, and determines that the group has not been changed (NO in S26) in a case where either or both of the conditions are not satisfied. If YES is determined in S26, the process proceeds to S27, and if NO is determined in S26, the process proceeds to S28.
(1) In S24, a change operation for a display position of a single node displayed in a predetermined display area associated with a certain group has been received.
(2) The position of the node after the change of the display position in S25 is within a predetermined display area associated with another group.

In S27, the grouping unit 202 updates a group. Specifically, the grouping unit 202 changes the group of an element relevant to the node whose display position has been changed, to a group associated with the position where that node is displayed. Note that one element may be allowed to belong to a plurality of groups. For example, it is assumed that, in a case where a display area associated with a certain group and a display area associated with another group have a superimposed portion, a node has been moved to the superimposed portion. In this case, the grouping unit 202 may set the group to which the element relevant to the moved node belongs, as both the certain group and the another group.

In S27, the display control unit 204 may reflect the update of the group in the display. For example, it is assumed that a node has been moved from a display area associated with a certain group to a display area associated with another group. In this case, the display control unit 204 may make the display area associated with the certain group (for example, the display area of the object b1 in FIG. 5) narrower and make the display area associated with the another group (for example, the display area of the object b3 in FIG. 5) wider.

In S28, the display control unit 204 determines whether to end the display of the causal graph. For example, the display control unit 204 may determine to end the display of the causal graph in a case where the reception unit 203 has received an operation to end the display of the causal graph. In a case where YES (that is, the display is to be ended) is determined in S28, the display control method in FIG. 7 is ended. On the other hand, in a case where NO (that is, the display is continued) is determined in S28, the process returns to S24.

As described above, the display control method according to the present example embodiment includes displaying nodes classified into a same group in association with each other in a causal graph in which causal relationships between a plurality of elements are represented by the nodes relevant to each element and edges indicating the causal relationships between each element (S23), receiving a change operation for display positions for the group (S26), and collectively changing the display positions of the nodes belonging to the same group targeted for the change operation, in accordance with the change operation (S25).

In the above display control method, the “causal relationship” can be replaced with any “relationship”, and the “causal graph” can be replaced with any “graph” indicating a relationship between any elements by using nodes and edges. Consequently, according to the display control method according to the present example embodiment, an effect that the arrangement of nodes in any graph indicating a relationship between elements by using nodes and edges can be efficiently changed can be obtained.

### Modified Examples

An executing entity of each process described in the above example embodiments is optional and is not limited to the above-described examples. That is, the functions of the information processing devices 1 and 2 can be achieved by a plurality of devices (can also be referred to as processors) capable of communicating with each other. For example, each process described in the flowcharts in FIGS. 2 and 7 can be executed by a plurality of processors in a shared manner. That is, the executing entity of the display control method in the above-described example embodiments may be one processor or a plurality of processors.

### Example Achieved by Software

Some or all of the functions of the information processing device 1 or 2 may be achieved by hardware such as an integrated circuit (IC chip) or may be achieved by software.

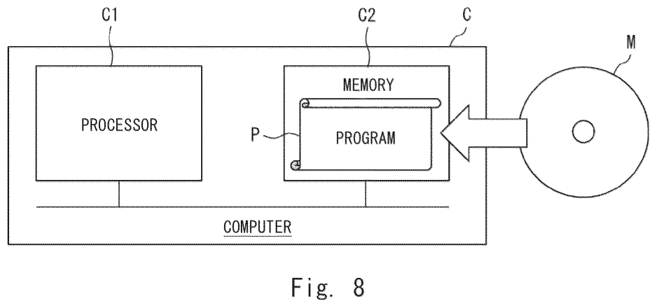

In the latter case, the information processing device 1 or 2 is achieved by, for example, a computer that executes a command of a program that is software for achieving each function. An example of such a computer (hereinafter, expressed as a computer C) is illustrated in FIG. 8. The computer C includes at least one processor C1 and at least one memory C2. A program (display control program) P for causing the computer C to operate as the information processing device 1 or 2 is recorded in the memory C2. In the computer C, the processor C1 reads and executes the program P from the memory C2 to achieve each function of the information processing device 1 or 2.

As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof, or the like can be used. As the memory C2, for example, a flash memory, a hard disk drive (HDD), a solid state drive (SSD), or a combination thereof, or the like can be used.

The computer C may further include a random access memory (RAM) for loading the program P at the time of execution and temporarily storing various sorts of data, for example. The computer C may further include a communication interface for sending and receiving data to and from another device. The computer C may further include an input/output interface for connecting input/output equipment such as a keyboard, a mouse, a display, and a printer.

The program P can be recorded in a non-transitory tangible recording medium M readable by the computer C. As such a recording medium M, for example, a tape, a disk, a card, a semiconductor memory, a programmable logic circuit, or the like can be used. The computer C can acquire the program P via such a recording medium M. The program P can be transmitted via a transmission medium. As such a transmission medium, for example, a communication network, a broadcast wave, or the like can be used. The computer C can also acquire the program P via such a transmission medium.

### Supplementary Information 1

The present disclosure is not limited to the above-described example embodiments, and various changes can be made without departing from the spirit and the scope as defined by the claims. For example, example embodiments obtained by appropriately combining the technical means disclosed in the above-described example embodiments are also included in the technical scope of the present disclosure.

### Supplementary Information 2

Some or all the above-described example embodiments may be described as follows. However, the present disclosure is not limited to the forms described below.

### Supplementary Note 1

An information processing device including:
a display control means for displaying nodes classified into a same group in association with each other in a graph in which relationships between a plurality of elements are represented by the nodes relevant to each element and edges indicating the relationships between each element; and
a reception means for receiving a change operation for display positions for the same group,
in which the display control means collectively changes the display positions of the nodes belonging to the same group targeted for the change operation, in accordance with the change operation.

### Supplementary Note 2

The information processing device according to Supplementary Note 1, further including a grouping means for grouping the elements,
in which the display control means displays the nodes relevant to each element classified into the same group by the grouping means, in association with each other.

### Supplementary Note 3

The information processing device according to Supplementary Note 2, in which the grouping means classifies the plurality of elements into a plurality of groups by exploratory factor analysis.

### Supplementary Note 4

The information processing device according to Supplementary Note 2, in which
the plurality of elements includes elements generated based on answers of respondents to a predetermined question, and
the grouping means classifies a plurality of the elements generated based on the answers relevant to same or related questions into the same group.

### Supplementary Note 5

The information processing device according to Supplementary Note 2, in which
the reception means receives designation of a threshold of a predetermined index value relating to the relationships between the plurality of elements,
the display control means switches between displaying and hiding of each node, based on the designated threshold, and
the grouping means groups the elements relevant to displayed nodes, as targets.

### Supplementary Note 6

The information processing device according to Supplementary Note 2, in which the grouping means identifies an optimal group of the each element, based on a form of a temporal change in values of the elements.

### Supplementary Note 7

The information processing device according to any one of Supplementary Notes 2 to 5, in which in a case where the nodes displayed in a predetermined display area associated with a certain group are moved to a predetermined display area associated with another group, the grouping unit changes classification of elements relevant to the nodes to the another group from the certain group.

### Supplementary Note 8

A display control method including:
displaying nodes classified into a same group in association with each other in a graph in which relationships between a plurality of elements are represented by the nodes relevant to each element and edges indicating the relationships between each element;
receiving a change operation for display positions for the same group; and
collectively changing the display positions of the nodes belonging to the same group targeted for the change operation, in accordance with the change operation,
by at least one processor.

### Supplementary Note 9

A display control program for causing a computer to execute:
a process of displaying nodes classified into a same group in association with each other in a graph in which relationships between a plurality of elements are represented by the nodes relevant to each element and edges indicating the relationships between each element;
a process of receiving a change operation for display positions for the same group; and
a process of collectively changing the display positions of the nodes belonging to the same group targeted for the change operation, in accordance with the change operation.

### Supplementary Information 3

Some or all of the above-described example embodiments may be further described as follows. An information processing device including at least one processor, in which the at least one processor executes: a process of displaying nodes classified into a same group in association with each other in a graph in which relationships between a plurality of elements are represented by the nodes relevant to each element and edges indicating the relationships between each element, a process of receiving a change operation for display positions for the same group, and a process of collectively changing the display positions of the nodes belonging to the same group targeted for the change operation, in accordance with the change operation.

Note that this information processing device may further include memory, and the memory may store the display control program for causing the at least one processor to execute the process of displaying the nodes in association with each other, the process of receiving the change operation, and the process of collectively changing the display positions. This display control program may be recorded in a non-transitory tangible computer-readable recording medium.

### Reference Signs List

1 information processing device
11 display control unit (display control means)
12 reception unit (reception means)
2 information processing device
202 grouping unit (grouping means)
203 reception unit (reception means)
204 display control unit (display control means)

What is claimed is:

1. An information processing device comprising a processor programmed to function as:
a display control unit configured to display nodes classified into a same group in association with each other in a graph in which relationships between a plurality of elements are represented by the nodes relevant to each element and edges indicating the relationships between each element; and
a reception unit configured to receive a change operation for display positions for the same group,
wherein the display control unit collectively changes the display positions of the nodes belonging to the same group targeted for the change operation, in accordance with the change operation.

2. The information processing device according to claim 1, the processor programmed to function as: further a grouping unit configured to group the elements,
wherein the display control unit displays the nodes relevant to each element classified into the same group by the grouping unit, in association with each other.

3. The information processing device according to claim 2, wherein the grouping unit classifies the plurality of elements into a plurality of groups by exploratory factor analysis.

4. The information processing device according to claim 2, wherein
the plurality of elements includes elements generated based on answers of respondents to a predetermined question, and
the grouping unit classifies a plurality of the elements generated based on the answers relevant to same or related questions into the same group.

5. The information processing device according to claim 2, wherein
the reception unit receives designation of a threshold of a predetermined index value relating to the relationships between the plurality of elements,
the display control unit switches between displaying and hiding of each node, based on the designated threshold, and
the grouping unit groups the elements relevant to displayed nodes, as targets.

6. The information processing device according to claim 2, wherein the grouping unit identifies an optimal group of the each element, based on a form of a temporal change in values of the elements.

7. The information processing device according to claim 2, wherein in a case where the nodes displayed in a predetermined display area associated with a certain group are moved to a predetermined display area associated with another group, the grouping unit changes classification of elements relevant to the nodes to the another group from the certain group.

8. A display control method comprising:
displaying nodes classified into a same group in association with each other in a graph in which relationships between a plurality of elements are represented by the nodes relevant to each element and edges indicating the relationships between each element;
receiving a change operation for display positions for the same group; and
collectively changing the display positions of the nodes belonging to the same group targeted for the change operation, in accordance with the change operation,
by at least one processor.

9. A non-transitory computer readable medium storing a display control program for causing a computer to execute:
a process of displaying nodes classified into a same group in association with each other in a graph in which relationships between a plurality of elements are represented by the nodes relevant to each element and edges indicating the relationships between each element;
a process of receiving a change operation for display positions for the same group; and
a process of collectively changing the display positions of the nodes belonging to the same group targeted for the change operation, in accordance with the change operation.
